(19) United States
(12) Patent Application Publication
(10) Pub. No.: US 2025/0115076 A1
(43) Pub. Date: Apr. 10, 2025

(54) WHEEL DISK

(71) Applicant: TOPY KOGYO KABUSHIKI KAISHA, Tokyo (JP)

(72) Inventors: Takayuki NONAKA, Tokyo (JP); Kenji MORISHITA, Tokyo (JP); Masashi OKADA, Tokyo (JP)

(21) Appl. No.: 18/833,150

(22) PCT Filed: Feb. 2, 2023
(86) PCT No.: PCT/JP2023/003385

§ 371 Date: Jul. 25, 2024

(30) Foreign Application Priority Data
Feb. 4, 2022 (JP) 2022-016223

(51) Int. Cl. B60B 3/04; B60B 3/00

(52) U.S. Cl. CPC B60B 3/045; B60B 3/007

(57) ABSTRACT

It is an objective of the present invention to reduce weight further in a wheel disk 1 for vehicle. A hat portion 20 of the wheel disk 1 for vehicle includes an annular top portion 21, an inner peripheral portion 22 and an outer peripheral portion 23. The inner peripheral portion 22 connects the top portion 21 and a hub attachment portion 10. The outer peripheral portion 23 connects the top portion 21 and welding flanges 30 and connects the top portion 21 and the window-forming flanges 40. The welding flanges 30 are welded to an inner periphery of a wheel rim 2. Windows 5 are formed between the window-forming flanges 40 and the inner periphery of the wheel rim 2. The outer peripheral portion 23 of the hat portion 20 includes first regions 231 and second regions 232 alternately in a circumferential direction. The first regions 231 are connected to the welding flanges 30 and the second regions 232 are connected to the window-forming flanges 40. Connecting portions 45 connecting the second regions 232 and the window-forming flanges 40 are protruded outward in an axial direction with respect to corresponding portions 231a of the first regions 231. The connecting portions and the corresponding portions are disposed at equal distances from a wheel central axis L.

### FIELD OF THE INVENTION

The present invention relates to a wheel disk used for a two-piece wheel for vehicle.

### BACKGROUND ART

A two-piece wheel for vehicle including a wheel disk and a wheel rim is well-known. The wheel disk includes a hub attachment portion, an annular hat portion disposed adjacent to the hub attachment portion outside in a radial direction and welding flanges extending from an outer peripheral edge of the hat portion. The welding flanges are welded to an inner periphery of a drop portion that is a smallest-diameter portion of the wheel rim.

The wheel disk is formed by drawing a blank having a flat-plate configuration. In a case where a blank made of a square-shaped plate material having four corners thereof cut off in arc-like configurations is used, portions of the blank in vicinities of four sides having arc-like configurations are bent, thereby the welding flanges extending inward in an axial direction (i.e., toward a vehicle) are obtained.

In the wheel disk disclosed in Japanese Unexamined Patent Application Publication No. 2017-52342 (Patent Document 1), window-forming flanges extending toward a vehicle are formed by bending portions of the blank in vicinities of straight-line sides of the blank as well. The window-forming flanges contribute to enhancing rigidity of the wheel disk, and further to reducing thickness and weight of the wheel disk.

### SUMMARY OF THE INVENTION

### Problem to be Solved by the Invention

Since the window-forming flanges of the wheel disk disclosed in the Patent Document 1 are protruded toward an inner space of a wheel for vehicle, interference with a brake received in the inner space should be avoided. To avoid the interference, the window-forming flanges are disposed outside with respect to the brake in a radial direction, which makes it difficult to reduce dimensions of the blank. This hinders further weight saving of the wheel disk.

### Solution to Problem

To solve the problems mentioned above, the present invention provides a wheel disk including: a hub attachment portion; a hat portion disposed adjacent to the hub attachment portion outside in a radial direction, the hat portion protruded outward in an axial direction, the hat portion including an annular top portion, an inner peripheral portion connecting the top portion and the hub attachment portion and an outer peripheral portion disposed outside of the top portion in the radial direction; a plurality of welding flanges and a plurality of window-forming flanges disposed alternately in a peripheral edge of the outer peripheral portion of the hat portion, the welding flanges and the window-forming flanges extending inward in the axial direction, wherein the welding flanges are welded to an inner periphery of a wheel rim, wherein the window-forming flanges are configured to form windows between the window-forming flanges and the inner periphery of the wheel rim, wherein the outer peripheral portion of the hat portion includes first regions connected to the welding flanges and second regions connected to the window-forming flanges wherein the first regions and the second regions are disposed alternately in a circumferential direction, wherein the second regions are connected to the window-forming flanges via connecting portions, the connecting portions are protruded outward in the axial direction with respect to corresponding portions of the first regions over ranges at least including centers of the connecting portions in the circumferential direction and wherein the connecting portions and the corresponding portions are disposed at equal distances from a wheel central axis.

According to the features mentioned above, amounts of protrusion of the window-forming flanges protruded in an inner space of a wheel for vehicle can be reduced. Therefore, it is not required that the window-forming flanges should be disposed outside of a brake in the radial direction to avoid interference with the brake received in the inner space, and the window-forming flanges can be disposed opposed to the brake in the axial direction. This allows for reduction of dimensions of the second regions of the wheel disk in the radial direction, thereby allowing for reduction of weight of the wheel disk. Further, since the interference with the brake can be avoided even with an increased width of the window-forming flanges in the axial direction, thickness and weight of the wheel disk can be reduced without compromising rigidity of the wheel disk.

Preferably, the connecting portions are protruded outward in the axial direction with respect to the corresponding portions of the first regions over entire lengths in the circumferential direction.

Preferably, the first regions extend from the top portion toward the welding flanges such that the first regions are inclined inward in the axial direction and wherein the second regions extend from the top portion in the radial direction toward the window-forming flanges such that the second regions are inclined outward in the axial direction.

According to the features mentioned above, the connecting portions connecting the second regions and the window-forming flanges can be protruded greatly outward in the axial direction.

Preferably, the outer peripheral portion of the hat portion includes transition regions between the first regions and the second regions and wherein the transition regions are inclined inward in the axial direction from the second regions toward the first regions along the circumferential direction.

According to the features mentioned above, forming of steps can be avoided between the first regions and the second regions, thereby constraining fatigue strength reduction due to concentration of stress.

Preferably, as differences between locations of the first regions and locations of the second regions in the axial direction are increased toward outside in the radial direction, widths of the transition regions in the circumferential direction are increased toward outside in the radial direction.

According to the features mentioned above, transition portions between the first regions and the second regions can be more gradual.

Preferably, the wheel disk is formed by drawing a blank having a configuration of a flat plate of a square shape having four corners thereof cut off in arc-like configurations, wherein the welding flanges are formed of vicinity portions of four sides of the blank having circular-arc configurations, wherein the window-forming flanges are formed of vicinity portions of four sides of the blank having straight-line configurations and wherein intersection portions connecting the welding flanges and the window-forming flanges extend in the axial direction.

According to the features mentioned above, since the welding flanges and the window-forming flanges are connected via the intersection portions, the rigidity of the wheel disk can be enhanced.

### Advantageous Effects of the Invention

According to the present invention, weight of the wheel disk can be further reduced.

### BRIEF DESCRIPTION OF THE DRAWINGS

FIG. 1 is a diagrammatic front view of a wheel for vehicle according to one embodiment of the present invention.

FIG. 2A is a cross-sectional view of FIG. 1 as viewed in a direction of arrows A-A.

FIG. 2B is a cross-sectional view of FIG. 1 as viewed in a direction of arrows B-B.

FIG. 3 is a front view of a wheel disk of the wheel for vehicle.

FIG. 4 is a side view of the wheel disk.

FIG. 5 is a perspective view of the wheel disk.

FIG. 6 is an enlarged cross-sectional view of an upper half of the wheel disk, in which an enlarged cross-sectional view corresponding to FIG. 2A is shown in solid lines and an enlarged cross-sectional view corresponding to FIG. 2B is shown in chain double-dashed lines.

FIG. 7A is a cross-sectional view of an upper half of a conventional wheel disk as a comparison example.

FIG. 7B is a cross-sectional view of an upper half of a wheel disk as another comparison example.

FIG. 7C is a cross-sectional view of an upper half of a wheel disk as still another comparison example.

FIG. 7D is a cross-sectional view of the upper half of the wheel disk according to the one embodiment of the present invention.

FIG. 8 is a front view of a blank to be formed into the wheel disk of the embodiment, presented with a comparison example which is shown in chain double-dashed lines.

### DESCRIPTION OF THE PREFERRED EMBODIMENTS

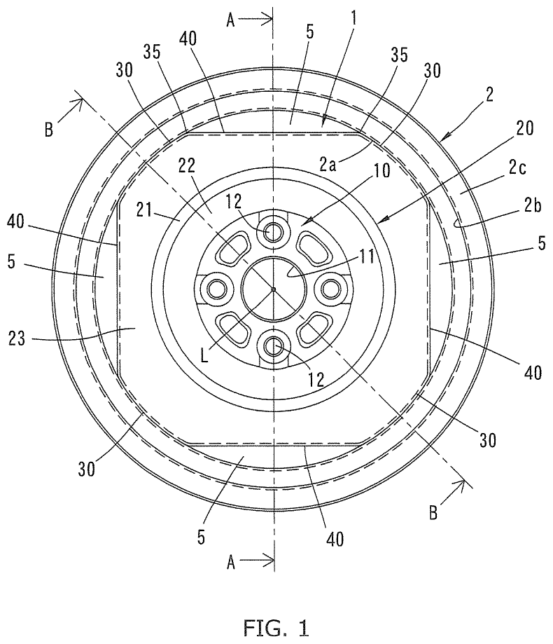

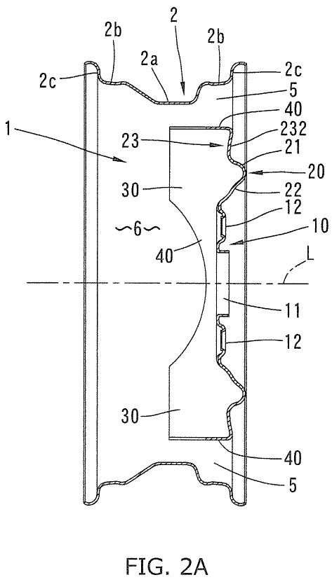

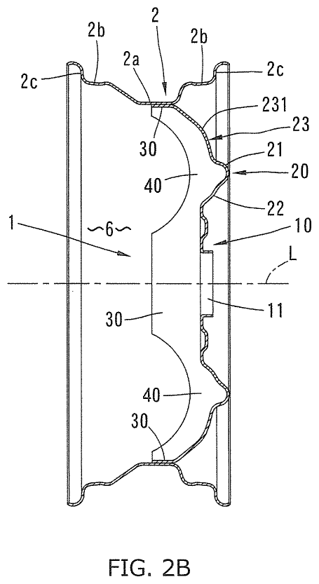

One embodiment of the present invention will be described hereinafter with reference to the drawings. As shown in FIGS. 1, 2A and 2B, a two-piece wheel for vehicle includes a wheel disk 1 and a wheel rim 2. In the drawings, a central axis of the wheel for vehicle is indicated by letter L. In the description, a vehicle side is defined as inside in an axial direction and a side opposite to the vehicle is defined as outside in the axial direction.

The wheel disk 1 includes a circular hub attachment portion 10 at a center, an annular hat portion 20 disposed adjacent to the hub attachment portion 10 outside in a radial direction, four (plurality of) welding flanges 30 and four (plurality of) window-forming flanges 40. The welding flanges 30 and the window-forming flanges 40 extend from an outer peripheral edge of the hat portion 20 and are disposed alternately.

The hub attachment portion 10 includes a hub hole 11 at a center and a plurality of, four, for example, bolt holes 12 arranged around the hub hole 11.

As shown in FIGS. 2A and 2B, the hat portion 20 has a mountain-shaped cross-sectional configuration along a diameter thereof protruded outward in the axial direction (toward the side opposite to the vehicle). The hat portion 20 includes a top portion 21 having an annular configuration, an inner peripheral portion 22 disposed adjacent to the top portion 21 inside in the radial direction and an outer peripheral portion 23 disposed adjacent to the top portion 21 outside in the radial direction. The inner peripheral portion 22 has a same cross-sectional configuration over an entire periphery thereof, that is inclined inwardly in the axial direction (toward the vehicle) from the top portion 21 toward the hub attachment portion 10. A peripheral edge of the outer peripheral portion 23 has a configuration having four circular-arc sides and four straight-line sides disposed alternately. A cross-sectional configuration of the outer peripheral portion 23 will be described later.

The welding flanges 30 are protruded inward in the axial direction in parallel to the wheel central axis L from the four circular-arc sides in the peripheral edge of the outer peripheral portion 23 of the hat portion 20, drawing a circular arc about the wheel central axis L. The window-forming flanges 40 are protruded inward in the axial direction in parallel to the wheel central axis L from the four straight-line sides in the peripheral edge of the outer peripheral portion 23 of the hat portion 20, having a flat-plate configuration. However, as shown in FIGS. 2A and 2B, the window-forming flanges 40 are curved when viewed in the radial direction.

The welding flanges 30 and the window-forming flanges 40 are disposed alternately in a circumferential direction. Specifically, the welding flanges 30 are disposed spaced from each other by equal distance (90 degrees) in the circumferential direction and the window-forming flanges 40 are disposed between the welding flanges 30. The welding flanges 30 and the window-forming flanges 40 are connected via intersection portions 35. The intersection portions 35 extend parallel to the central axis L.

Features of the wheel rim 2 are well-known, thus not to be described in detail here. The wheel rim 2 includes a wheel rim drop portion 2a that is a smallest-diameter portion, a pair of bead seat portions 2b disposed on opposite sides of the rim drop portion 2a in the axial direction and a pair of wheel rim flanges 2c disposed on further opposite sides of the wheel rim drop portion 2a with respect to the bead seat portions 2b in the axial direction.

The welding flanges 30 of the wheel disk 1 are fitted to and welded to an inner periphery of the drop portion 2a of the wheel rim 2. The window-forming flanges 40 are spaced from an inner periphery of the wheel rim 2 since the window-forming flanges 40 are less distanced from the central axis L than the welding flanges 30. Windows 5 are formed between the window-forming flanges 40 and the inner periphery of the wheel rim 2. The wheel for vehicle has an inner space 6 defined by the wheel disk 1 and the wheel rim 2.

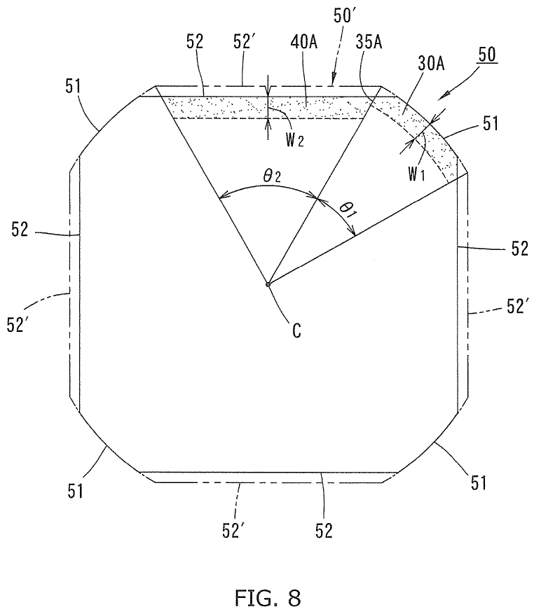

The wheel disk 1 is formed by drawing a blank 50 having a flat-plate configuration indicated by solid lines in FIG. 8. The blank 50 is obtained by cutting off four corners of a square-shaped plate material. Accordingly, a peripheral edge of the blank 50 has four circular-arc sides 51 and four straight-line sides 52. The hub attachment portion 10, the hat portion 20, the welding flanges 30 and the window-forming flanges 40 are obtained by drawing the blank 50. Portions 30A of the blank 50 having a predetermined width W₁ along the circular-arc sides 51 become the welding flanges 30 and portions 40A of the blank 50 having a predetermined width W₂ along the straight-line sides 52 become the window-forming flanges 40.

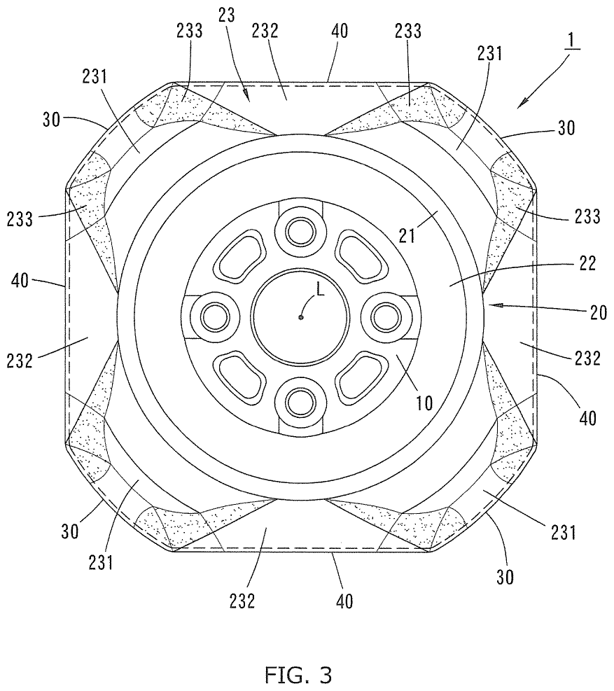

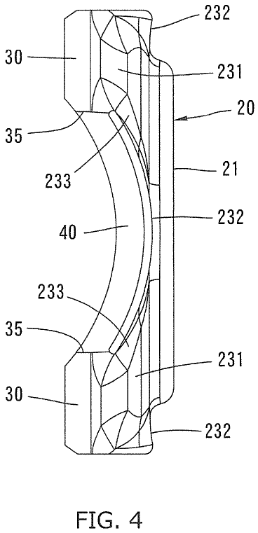

A shape of the outer peripheral portion 23 of the hat portion 20 which is a main characteristic portion of the invention of the present application will be described hereinafter. In FIGS. 3 to 5, boundaries of different surface regions of complicated shapes of the outer peripheral portion 23 are indicated by a multitude of thin lines. The outer peripheral portion 23 includes four first regions 231 between the top portion 21 and the welding flanges 30, four second regions 232 between the top portion 21 and the window-forming flanges 40 and transition regions 233 disposed between the first regions 231 and the second regions 232. To help distinguishing these regions, the transition regions 233 are dotted in FIG. 3.

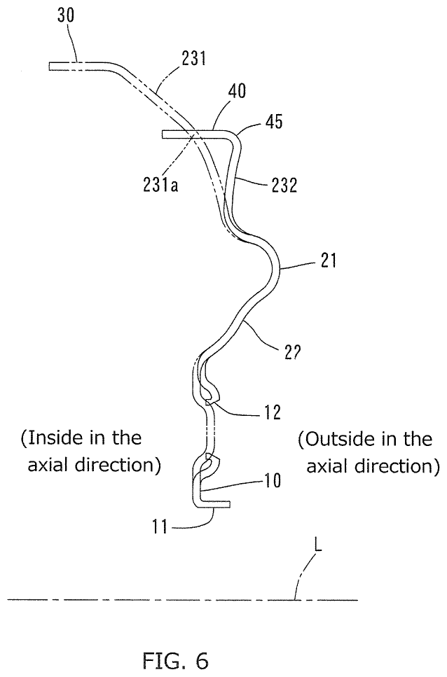

As shown in FIG. 2B and in FIG. 6 by chain double-dashed lines, the first regions 231 extend from the top portion 21 of the hat portion 20 to the welding flanges 30 inclined inward in the axial direction toward outside in the radial direction, changing angles of inclination. Cross-sectional configurations of the first regions 231 are similar to those of a conventional wheel disk.

Cross-sectional configurations of the second regions 232 are different from those of the first regions 231. Specifically, as shown in FIG. 2A and in FIG. 6 by solid lines, the second regions 232 extend from the top portion 21 to the window-forming flanges 40 mildly inclined outward in the axial direction toward outside in the radial direction. Accordingly, outer edges of the second regions 232 in the radial direction, i.e., boundaries or connection portions 45 between the second regions 232 and the window forming flanges 40 are disposed outside in the axial direction with respect to corresponding portions 231a of the first regions 231, which is located at same distances from the central axis L as the connecting portions 45 over entire lengths thereof. Thanks to this arrangement, protruded amounts of the window-forming flanges 40 from the corresponding portions 231a inward in the axial direction can be reduced.

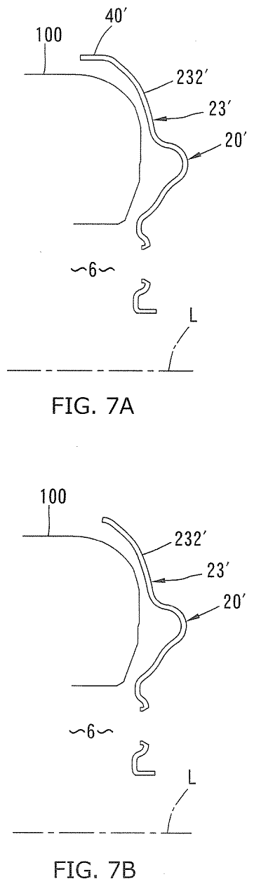

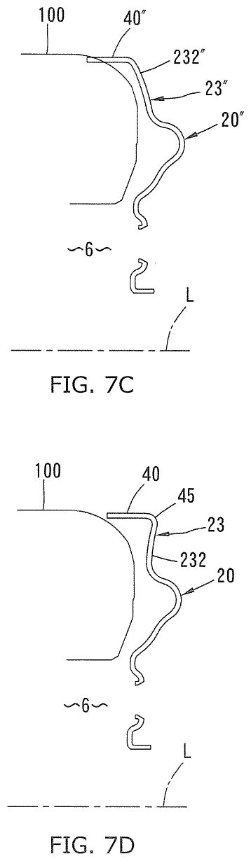

The features mentioned above allow for reduction of weight of the wheel disk 1. The reasons therefor will be described in detail hereinafter with reference to FIGS. 7A to 7D. When a brake is received in the inner space 6 of the wheel for vehicle, it is required that interference between the wheel for vehicle and the brake should be avoided. In a case of a disk brake, it is particularly required to avoid interference with a brake caliper 100.

FIG. 7A shows a conventional wheel disk as a comparison example. Portions of an outer peripheral portion 23′ of a hat portion 20′ of the wheel disk at an equal distance from a central axis L have same cross-sectional configurations over an entire periphery. That is, regions 232′ connected to window-forming flanges 40′ have same cross-sectional configurations as regions connected to welding flanges until the regions 232′ reach the window-forming flanges 40′. (However, widths of the window-forming flanges 40′ in an axial direction are smaller than widths of the welding flanges in the axial direction.) Since the window-forming flanges 40′ are disposed outside of a brake caliper 100 in a radial direction, interference with the brake caliper 100 can be avoided. However, since distances from the wheel central axis L to the window-forming flanges 40′ are long, it is required that distances from a central point C of a blank 50′ to straight-line sides 52′ of the blank 50′ should be sufficiently long as shown in FIG. 8 in chain double-dashed lines. This arrangement does not permit dimensions of the blank 50′ to be reduced for weight saving.

Even when dimensions of the blank 50 are reduced by bringing the straight-line sides 52 of the blank 50 closer to the central point C as shown in solid lines in FIG. 8, the wheel disk does not interfere with the brake caliper 100 unless window-forming flanges extending in the axial direction are formed, as shown in FIG. 7B. However, strength of the wheel disk may be reduced.

In a case where the dimensions of the blank 50 are reduced by bringing the straight-line sides 52 of the blank 50 closer to the central point C as shown in solid lines in FIG. 8, window-forming flanges 40″ may interfere with the brake caliper 100 if, as shown in FIG. 7C, regions 232″ connected to the window-forming flanges 40″ have same cross-sectional configurations as those of regions connected to welding flanges in an outer peripheral portion 23″ of a hat portion 20″.

In the present embodiment, the blank 50 with reduced dimensions indicated by the solid lines in FIG. 8 is used as with the comparison example of FIG. 7C. The window-forming flanges 40 are formed. However, as shown in FIG. 7D, the second regions 232 are mildly inclined in opposite directions from the first regions 231 and the connecting portions 45 connecting the second regions 232 and the window-forming flanges 40 are displaced outward in the axial direction with respect to the corresponding portions 231a (FIG. 6) of the first regions 231. Thereby, amounts of the window-forming flanges 40 protruded toward the inner space 6 can be reduced. As a result, the interference between the window-forming flanges 40 and the brake caliper 100 can be avoided.

Further, the displacement of the connecting portions 45 connecting the second regions 232 and the window-forming flanges 40 outward in the axial direction allows for increase in width of the window-forming flanges 40 in the axial direction without interfering with the brake. Thereby, rigidity of the wheel disk 1 can be enhanced and thickness and weight of the wheel disk 1 can be further reduced.

Roles of the transition regions 233 will be described hereinafter. Since the second regions 232 are protruded outward in the axial direction with respect to the first regions 231, edges of the first regions 231 in the circumferential direction and edges of the second regions 232 in the circumferential direction are located in different positions in the axial direction. The transition regions 233 are inclined such that the positions in the axial direction are gradually shifted inward in the axial direction from the second regions 232 toward the first regions 231. Thereby, formation of steep steps at boundaries between the first regions 231 and the second regions 232 can be avoided, which allows for reduction of concentration of stress.

In this embodiment, the differences in the positions in the axial direction between the edges of the first regions 231 in the circumferential direction and the edges of the second regions 232 in the circumferential direction are increased towards outside in the radial direction. However, increase in the difference in the positions in the axial direction is gradual since widths of the transition regions 233 in the circumferential direction are increased towards outside in the radial direction.

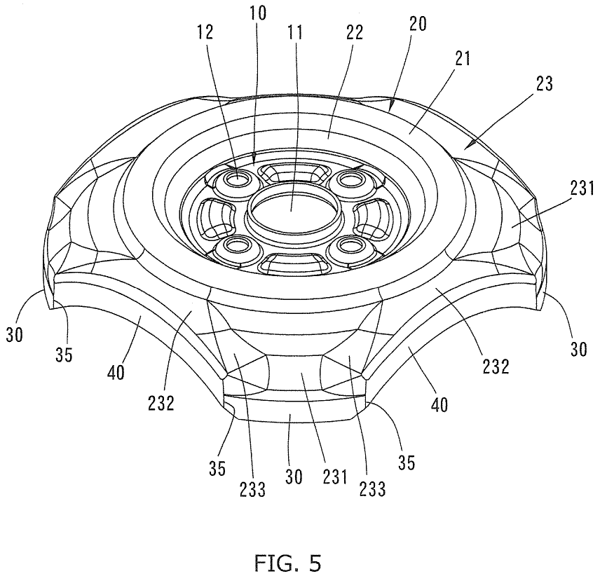

There are limitations to reduction in the dimensions of the blank 50, which will be explained hereinafter with reference to FIG. 8. Portions to be welding flanges 30A that correspond to the welding flanges 30 are defined by an angle θ₁ and a predetermined width W₁. Portions to be window-forming flanges 40A that correspond to the window-forming flanges 40 are defined by an angle θ₂ and a predetermined width W₂. Preferably, distances between the straight-line sides 52 and the central point C are determined such that boundaries 35A remain between the portions to be welding flanges 30A and the portions to be window-forming flanges 40A. After the forming, the boundaries 35A become the intersection portions 35 (refer to FIG. 5) that connect the welding flanges 30 and the window-forming flanges 40.

The present invention is not limited to the embodiment described above, and various modifications can be adopted without departing from the scope and the spirit of the invention.

In the embodiment described above, distal ends of the window-forming flanges 40 are protruded inward in the axial direction with respect to the corresponding portions 231a of the first regions 231 as shown in FIG. 6. Alternatively, the distal ends of the window-forming flanges 40 may be at same locations as the corresponding portions 231a in the axial direction or may be disposed outward in the axial direction with respect to the corresponding portions 231a.

In the embodiment described above, the second regions 232 are mildly inclined outward in the radial direction toward outside in the axial direction. Alternatively, the second regions 232 may extend in a direction orthogonal to the wheel central axis. Alternatively, the second regions 232 may be inclined inward in the axial direction toward outside in the radial direction. (In this case, the inclination of the second regions should be milder than the inclination of the first regions.)

In the embodiment described above, the connecting portions 45 connecting the window-forming flanges 40 and the second regions 232 are protruded outward in the axial direction with respect to the corresponding portions 231a of the first regions 231 over the entire length in the circumferential direction. In another embodiment, only predetermined ranges of the connecting portions 45 including centers in the circumferential direction may be protruded outward in the axial direction with respect to the corresponding portions 231a. It is not required that portions in vicinity of opposite ends of the connecting portions 45 should be protruded outward in the axial direction with respect to the corresponding portions 231a.

In this embodiment, the second regions 232 are slightly curved outward in the axial direction along a circumferential direction. Alternatively, the second regions 232 may have flat configurations. It is not required that the window-forming flanges should have flat-plate configurations. The window-forming flanges may be curved.

### INDUSTRIAL APPLICABILITY

The present invention may be applied to a wheel for vehicle.

1. A wheel disk comprising:
a hub attachment portion;
a hat portion disposed adjacent to the hub attachment portion outside in a radial direction, the hat portion protruded outward in an axial direction, the hat portion comprising an annular top portion, an inner peripheral portion connecting the top portion and the hub attachment portion and an outer peripheral portion disposed outside of the top portion in the radial direction;
a plurality of welding flanges and a plurality of window-forming flanges disposed alternately in a peripheral edge of the outer peripheral portion of the hat portion, the welding flanges and the window-forming flanges extending inward in the axial direction,
wherein the welding flanges are welded to an inner periphery of a wheel rim,
wherein the window-forming flanges are configured to form windows between the window-forming flanges and the inner periphery of the wheel rim,
wherein the outer peripheral portion of the hat portion comprises first regions connected to the welding flanges and second regions connected to the window-forming flanges wherein the first regions and the second regions are disposed alternately in a circumferential direction,
wherein the second regions are connected to the window-forming flanges via connecting portions, the connecting portions are protruded outward in the axial direction with respect to corresponding portions of the first regions over ranges at least including centers of the connecting portions in the circumferential direction and wherein the connecting portions and the corresponding portions are disposed at equal distances from a wheel central axis.

2. The wheel disk according to claim 1, wherein the connecting portions are protruded outward in the axial direction with respect to the corresponding portions of the first regions over entire lengths in the circumferential direction.

3. The wheel disk according to claim 1, wherein the first regions extend from the top portion toward the welding flanges such that the first regions are inclined inward in the axial direction and wherein the second regions extend from the top portion in the radial direction toward the window-forming flanges such that the second regions are inclined outward in the axial direction.

4. The wheel disk according to claim 1, wherein the outer peripheral portion of the hat portion comprises transition regions between the first regions and the second regions and wherein the transition regions are inclined inward in the axial direction from the second regions toward the first regions along the circumferential direction.

5. The wheel disk according to claim 4, wherein as differences between locations of the first regions and locations of the second regions in the axial direction are increased toward outside in the radial direction, widths of the transition regions in the circumferential direction are increased toward outside in the radial direction.

6. The wheel disk according to claim 1, wherein the wheel disk is formed by drawing a blank having a configuration of a flat plate of a square shape having four corners thereof cut off in arc-like configurations, wherein the welding flanges are formed of vicinity portions of four sides of the blank having circular-arc configurations, wherein the window-forming flanges are formed of vicinity portions of four sides of the blank having straight-line configurations and wherein intersection portions connecting the welding flanges and the window-forming flanges extend in the axial direction.
